(19) United States
(12) Patent Application Publication
(10) Pub. No.: US 2019/0156433 A1
(43) Pub. Date: May 23, 2019

(54) EVENT PROCESSING AND ALLOCATION

(71) Applicant: Shanghai Bilibili Technology Co., Ltd., Shanghai (CN)

(72) Inventors: Xiaoshan LIN, Shanghai (CN); Fang FANG, Shanghai (CN)

(21) Appl. No.: 16/194,031

(22) Filed: Nov. 16, 2018

(30) Foreign Application Priority Data
Nov. 17, 2017 (CN) 201711146536.4

(51) Int. Cl. G06Q 50/00; G07C 13/00; G06Q 30/02

(52) U.S. Cl. CPC G06Q 50/01; G06Q 30/0282; G07C 13/00

(57) ABSTRACT

Techniques for processing events in a network community are described herein. The disclosed techniques include receiving an event from a user account, the event comprising at least one reason for submitting the event and at least one attribute of content associated with the event; determining whether the event is to be crowd discussed based on at least in part on the at least one reason and the at least one attribute of content; and assigning the event in the crowd discussion list to a zone based at least in part on the at least one attribute of content associated with the event. The event may be a report from the user account. The disclosed techniques further include determining whether the report is to be crowd adjudicated based at least in part on a report weigh value corresponding to the user account and determining whether to allocate any report in the crowd adjudication list to a review account based on a plurality of predetermined rules.

### BACKGROUND

Users may attempt to access conventional social media on their devices to communicate about interesting content. Using conventional social media may be cumbersome as users may have to switch back and forth between different applications to access the content of interest and social media related to the content. As communication devices, such as mobile phones, become more sophisticated, people continue to discover new ways to communicate.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 is a schematic diagram illustrating an example system that may be used in accordance with the present disclosure;

FIG. 2 is a schematic diagram illustrating an example process for combining content that may be used in accordance with the present disclosure;

FIG. 3 is a schematic diagram illustrating an example computing device that may be used in accordance with the present disclosure;

FIG. 4 is a schematic diagram illustrating an example server that may be used in accordance with the present disclosure;

FIG. 5 is a flowchart illustrating an example process of the first embodiment of the present disclosure;

FIG. 6 is a flowchart illustrating an example process of the second embodiment of the present disclosure;

FIG. 7 is a flowchart illustrating an example process of the third embodiment of the present disclosure;

FIG. 8 is a flowchart of the substeps of Step S32 in FIG. 6;

FIG. 9 is a flowchart of the substeps of Step S33 in FIG. 6;

FIG. 10 is a flowchart illustrating an example process of the fourth embodiment of the present disclosure;

FIG. 11 is a flowchart illustrating an example process of the fifth embodiment of the present disclosure;

FIG. 12 is a flowchart illustrating an example process of the sixth embodiment of the present disclosure;

FIG. 13 is a structure block diagram of an example server of the seventh embodiment of the present disclosure;

FIG. 14 is a structure block diagram of an example system of the eighth embodiment of the present disclosure;

FIG. 15 is a structure block diagram of an example system of the ninth embodiment of the present invention.

### DETAILED DESCRIPTION OF ILLUSTRATIVE EMBODIMENTS

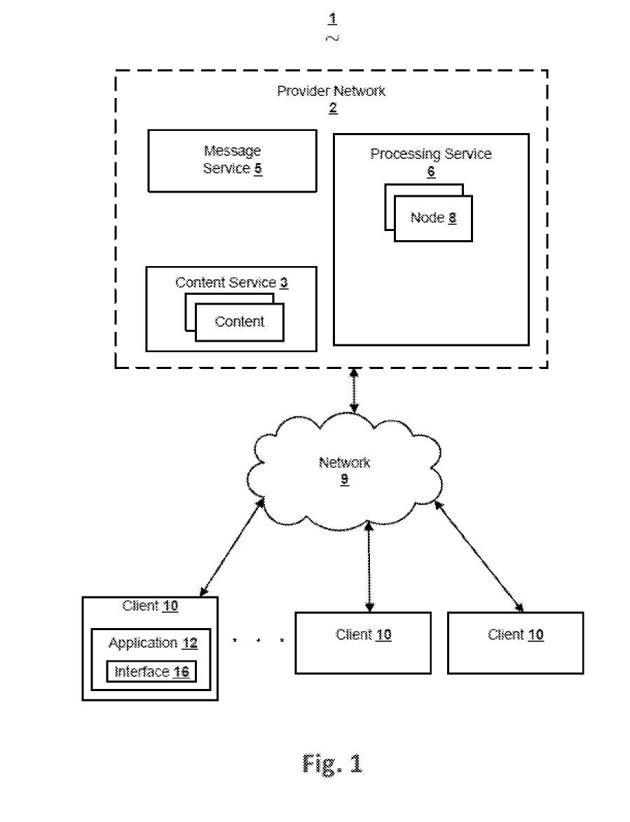

FIG. 1 is a schematic diagram showing an example system 1 that may be used in accordance with the present disclosure. The system 1 may comprise a provider network 2 and a plurality of client devices 10. The provider network 2 and the plurality of client devices 10 may communicate with each other via one or more networks 9.

In some embodiments, the content service 3 may be implemented as part of the provider network 2. In other embodiments, the content service 3 may be managed by a separate service provider than a service provider of the provider network 2. It should also be understood that the provider network 2 may provide additional content services separate from the content service 5.

The content service 3 may comprise a content streaming service, such as an Internet protocol video streaming service. The content streaming service may be configured to distribute content via a variety of transmission techniques. The content service 3 may be configured to provide the content, such as video, audio, textual data, a combination thereof, and/or the like. The content may comprise content streams (e.g., video stream, audio stream, information stream), content files (e.g., video file, audio file, text file), and/or other data. The content may comprise gaming content. For example, the content service 5 may comprise a collaborative gaming platform, a video sharing service, a video hosting platform, a content distribution platform, and/or the like.

The provider network 2 may implement a commentary service configured to allow users to comment and/or share comments associated with content. The comments may be displayed with the content on the same screen. For example, the comments may be displayed in an overlay above the content. The comments may be encoded into a format of the content. For example, the comments may be encoded as video content as the original content. The comments may be animated when displayed. For example, the comments may be shown scrolling (e.g., from right to left, left to right, top to bottom, bottom to top) across the content, which may be referred to as “bullet screen.”

The provider network 2 may be located at a data center, such as a single premises, or be distributed throughout different geographic locations (e.g., at several premises). The provider network 2 may provide the services via the one or more networks 9. The networks 9 comprise a variety of network devices, such as routers, switches, multiplexers, hubs, modems, bridges, repeaters, firewalls, proxy devices, and/or the like. The networks 9 may comprise physical links, such as coaxial cable links, twisted pair cable links, fiber optic links, a combination thereof, and/or the like. The networks 9 may comprise wireless links, such as cellular links, satellite links, Wi-Fi links and/or the like.

The provider network 2 may comprise a message service 5. The message service 5 may be configured to receive a plurality of messages. The plurality of messages may comprise a plurality of comments associated with content and information related to the plurality of comments. The plurality of messages may be associated with a particular content item, content session, and/or the like.

The message service 5 may be configured to manage messages for various content items. Users may browse content and access different content items to view comments for particular content, such as comments posted by other users for that particular content. Comments from users associated with a particular content item may be output to other users watching the particular content item. For example, all users accessing a content item (e.g., video clip) may view comments associated with the content item. Comments that are input may be output in real-time or near-real-time.

The message service 5 may be configured to process the plurality of messages. The message service 5 may implement a queue or otherwise prioritize processing of the plurality messages based on information, e.g., time stamps, incremented identifier, associated with corresponding comments. The message service 5 may be configured to process the plurality of messages using load balancing. For example, the message service 5 may be configured to use one or more of the plurality of processing nodes to process the messages, prioritize the messages, load balance the messages, and/or the like. The message service 5 may store, at least temporarily, the plurality of messages. The message service 5 may store the messages in a datastore, such as a database.

The message service 5 may be configured to process a message by performing a grouping process. The grouping process may comprise grouping messages based on a characteristic. If two messages have the same characteristic or are within a threshold range of a characteristic, then the messages may be grouped. Messages associated with a particular content item (e.g., stream, file, show, movie, song, game session) may be associated with the same group. For example, a message may comprise or be associated with a content identifier. The content identifier may uniquely identify the content item. The message service 5 may associate a message with a group associated with the content item if the content identifier is found in the message or otherwise associated with the message (e.g., sent separately).

The message service 5 may perform natural language processing, topic recognition, pattern recognition, artificial intelligence, and/or the like to automatically determine characteristics of the messages and/or group the messages. As an example, frequently occurring phrases or patterns may be identified as topics. As another example, a database of topics associated with content may be maintained. The topics may include genres (e.g., action, drama, comedy), personalities (e.g., actors, actresses, directors), languages, and/or the like. Messages may be grouped based on characteristics of the client device and/or users sending the messages. Demographics, interests, history, and/or like may be stored for a plurality of users to determine potential groupings of messages.

The message service 5 may be configured to process messages by determining contexts for outputting (e.g., displaying, presenting) comments comprised in the messages. The context may comprise a context for outputting a comment based on the grouping. The context may comprise a time context associated with a time to output the comment.

A message may indicate a time when a comment was input by a user. The time may comprise a time internal to the content item or other similar information, such as fragment identifiers. For example, the time may indicate a portion of the content item (e.g., one or more content fragments) that was viewed by a user when the user input a comment. The time may indicate when a user started inputting the comment, a duration of inputting, a time when the input was submitted, and/or the like.

The message service 5 may determine to output a comment during or close to the portion of content item being commented. In an example, if multiple messages are received for a portion of time (e.g., a scene), then a time offset may be added to some of the messages to prevent all of corresponding comments from being output at the same time.

The context may further comprise a graphical context associated with a form of the comment. The graphical context may comprise a size, a color, a font, and/or the like. The context may comprise a moving context in which the comment moves when output. The moving context may comprise an animation. For example, the moving context may comprise a direction of movement (e.g., left to right, right to left, up to down, down to up, diagonally). The moving context may comprise any type of animation, such as a spinning motion, a waving motion, a zig-zag, a circular motion, increasing in size, decreasing in size, and/or the like.

The context may be determined based on a preference associated with a message. For example, a user may specify a preference for how a corresponding comment is to be output. The user may specify the context for a particular comment. The context may be determined based on a characteristic of a particular content item. For example, the graphical context may be determined based on the background color of the content item during a particular segment. The graphical context may contrast with the background color of the content item.

The message service 5 may be further configured to process a message by generating output data. The output data may comprise instructions for implementing outputting a comment based on corresponding context. The output data may comprise application data for instructing an application to overlay the comment based on the context. The output data may comprise instructions for generating (e.g., encoding) content corresponding to a comment.

The output data may be used to generate (e.g., encode) output commentary content, such as an output content stream. The output commentary content may be combined (e.g., multiplexed) with original content item such as the content provided by the content service 3. The resulting combination may comprise content in a single package (e.g., container, transport container, transport stream). The package may comprise the original content item along with the output commentary content (e.g., displayed on top of the original content item).

The message service 5 may be further configured to process messages by performing a screening process. The screening process may comprise rejecting or flagging messages that match screening criteria. The screening criteria may specify terms and/or phrases, such as profanity, hate speech, indecent language, and/or the like. The screening criteria may specify characters, such as symbols, fonts, and/or the like. The screening criteria may specify languages, computer readable code patterns, and/or the like.

The provider network 2 may further comprise a processing service 6. The processing service 6 may be configured to provide processing for a variety of services, such as the services of the provider network 2. The processing service 6 may comprise a plurality of processing nodes 8 (e.g., as a service). The plurality of processing nodes 8 may process tasks associated with a message service 5. The plurality of processing nodes 8 may be implemented as one or more computing devices, one or more processors, one or more virtual computing instances, a combination thereof, and/or the like.

The plurality of processing nodes 8 may be implemented by one or more computing devices. The one or more computing devices may comprise virtualized computing instances. The virtualized computing instances may comprise a virtual machine, such as an emulation of a computer system, operating system, server, and/or the like. A virtual machine may be loaded by a computing device based on a virtual image and/or other data defining specific software (e.g., operating systems, specialized applications, servers) for emulation. Different virtual machines may be loaded and/or terminated on the one or more computing devices as the demand for different types of processing services changes. A hypervisor may be implemented to manage the use of different virtual machines on the same computing device.

The plurality of processing nodes 8 may comprise nodes associated with providing specific services (e.g., processing tasks). The nodes may be dedicated to providing these specific services. For example, the plurality of processing nodes 8 may implement a receiver, a content generator, a combiner, a transcoder, a combination thereof; the plurality of processing nodes 8 may also process events submitted by the plurality of client computing devices. The events may be associated with crowd topics for discussing real-time news, movies, or television programs; social hot topics; reports, and/or the like. In some implementations, these services may be implemented as dedicated computing devices, dedicated processors, dedicated virtual machine instances, and/or the like. In other implementations, a variety of different nodes may implement any of the functions associated with these services.

The plurality of client devices 10 may be configured to access the content and the services of the provider network 2. The plurality of client devices 10 may comprise any type of computing device, such as a mobile device, a tablet device, laptop, a computing station, a smart device (e.g., smart apparel, smart watch, smart speaker, smart glasses), a virtual reality headset, a gaming device, a set top box, digital streaming device, robot, a vehicle terminal, a smart TV, a TV box, an e-book reader, MP3 (Moving Picture Experts Group Audio Layer III) players, MP4 (Moving Picture Experts Group Audio Layer IV) players, and so on.

The plurality of client devices 10 may be associated with one or more users. A single user may use one or more of the plurality of client devices 10 to access the provider network 2. The plurality of client devices 10 may travel to a variety of locations and use different networks to access the provider network 2.

An example client device 10 may comprise an application 12. The application 12 outputs (e.g., display, render, present) content to a user. The content may comprise videos, audio, comments, textual data and/or the like. The application 12 may also provide a menu for navigating a variety of content.

The client device 10 may access an interface 16 that allows users to provide comments associated with corresponding content and submit events to a processing service. The interface 16 may comprise an input element. For example, the input element may be configured to receive input from a user, such as comments associated with a particular content, events, user accounts, and/or the like. In some embodiments, the interface 16 may be implemented as part of the application 12.

The application 12 may allow a user to set a context (e.g., color, font size, animation, emoji, scrolling direction) associated with his or her input. The application 132 may determine (e.g., automatically) other context information, such as timing information (e.g., start time, duration, end time for the input). The application 12 may send the input, the context, the context information, and/or other information to the message service 5 of the provider network 2. The application 12 may also send events to a processing service. As an example, the application 12 may send an event comprising reasons of submitting the event, content attributes associated with the event, account information of the user account, and/or the like. The techniques for processing events in accordance with the present disclosure can be implemented by the example system as shown in FIG. 1

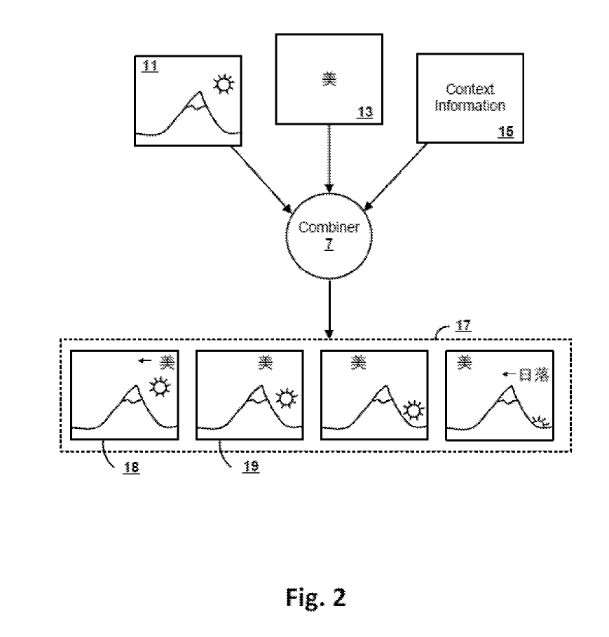

FIG. 2 is a schematic diagram showing an example process for combining content. A combiner 7 may be configured to receive content 11. As illustrated in this example, the content 11 may comprise a video. It should be understood that other content may be used. The content 11 may comprise a plurality of frames, such as a series of images. The plurality of frames may be time ordered. For example, a first frame maybe ordered before a second frame.

The combiner 7 may be implemented by any of the services and/or devices described herein. For example, the combiner 7 may be implemented by the processing service 6 or the message service 5 of the provider network 2. In other examples, the combiner 7 may be implemented by the application 12 of the client devices 10.

The combiner 7 may be configured to receive message data 13 associated with the content 11. The message data 13 may comprise one or more characters. As illustrated in this example, shown in FIG. 2, a Chinese character [symbol] is shown. It should be understood, that the message data 13 may comprise multiple characters, symbols, and/or like in one or more languages. For example, the message data 13 may comprise comments from users associated with the content 11.

The combiner 7 may be further configured to receive context information 15. The context information 15 may indicate a context for rendering the message data 13 associated with the content 11. The context information 15 may comprise timing information indicating a time to render the message data 13 with the content 11. The context information 15 may comprise a start time associated with the message data, a scrolling speed, a font size, a font color, an end time associated with the message data, and/or other relevant information.

The combiner 7 may be configured to combine the content 11 and the message data 13 to generate combined content 17 based on the context information 15. The combiner 7 may combine the content 11 and the message data 13 by generating a content package. The content package may comprise a container, such as a transport container (e.g., MPEG transport or other transport container), a formatted container (e.g., as specified for an encoding format). The content package may comprise instructions for a rendering engine to render the content 11 and the message data 13 at least partially together.

As shown in FIG. 2, the combiner 7 may combine the content 11 and the message data 13 by generating a modified video. For example, at least a portion of the message data may be added to the plurality of frames. The message data may be animated separately from the video and/or may be combined with (e.g., overlain, inserted into, added to, associated with, encoded into) frames of the video.

Using the content information, positions (e.g., relative to the plurality of frames) for the message data (e.g., characters) may be determined for one or more (or each) of the plurality of frames. A first position may be determined for a first frame 18. A second position may be determined for the second frame 19. The second position may be different than the first position. The second position may be determined based on the first position.

For example, a path for rendering characters of the message data may be determined. The path may specify a direction for animating and/or scrolling text above the content 11. The direction may vary. For example, the path may be curvilinear. The second position may be further along the path than the first position (e.g., if the second frame is after the first frame in the time ordering). If the path is from right to left, as shown in FIG. 2, then the second position may be further left than the first position. The combiner 7 may combine the content 11 and the message data 13 in a manner that the message data 13 is successively rendered along the path as the plurality of frames of the content progress.

Though only one character is shown, the combiner 7 may be configured to receive message data from a variety of sources at any time and combine the message data 13 with the content 11. For example, message data 13 from a plurality of users may be received and combined with the content 11. Different message data 13 may be combined in a manner that the message data 13 is rendered at least partially simultaneously.

For example, several messages from different users (e.g., another user may comment “ [symbol] ” or sunset) may be rendered at least partially at the same time with the content 11. The message data may be combined in a manner that allows for the content 11 to remain viewable during rendering of the message data. For example, the message data may be combined with the content 11 using constraints that limit the number of messages shown simultaneously, limit the location of message data (e.g., shown in areas where pixels have less change, shown in background areas of the content), and/or the like as described further herein. As an example, the message data may be shown in a background, such as the sky behind a mountain in the example of FIG. 2. In other embodiments, the message data are not received as a series of messages, but rather the messages are combined and rendered by a separate service. In such an embodiment, the messages are not separately identifiable by the combiner 7 but rather are received as, e.g., a video overlay.

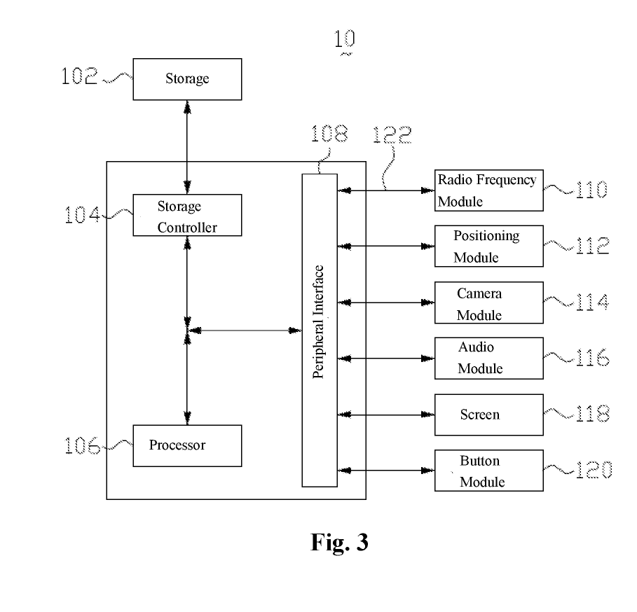

FIG. 3 shows a structure block diagram of an example client computing device. As shown in FIG. 3, the client computing device 10 includes a storage 102, a storage controller 104, one or more (only one is shown in the figure) processors 106, a peripheral interface 108, a radio frequency module 110, a positioning module 112, a camera module 114, an audio module 116, a screen 118, and a button module 120. These components communicate with each other through one or more communication buses/signal lines 122.

It can be understood that the structure shown in FIG. 3 is illustrative only, and the client computing device 10 may also include more or fewer components than those shown in FIG. 3, or may have a configuration different from that shown in FIG. 3. The components shown in FIG. 3 can be implemented by hardware, software or their combination.

The storage 102 can be used to store software programs and modules, such as program instructions/modules corresponding to the case allocation methods, the case allocation systems, the event allocation methods and the event allocation systems in the embodiments of the present invention, the processor 106 runs the software programs and modules stored in (the storage 102, so as to perform various functional applications and data processing, that is, to realize the case allocation methods, the case allocation systems, the event allocation methods and the event allocation systems mentioned above.

The storage 102 may include high-speed random access storages and may also include non-volatile storages, such as one or more magnetic storage devices, flash storages, or other non-volatile solid-state storages. In some embodiments, the storage 102 may further include storages set remotely relative to the processor 106, these remote storages can be connected to the client computing device 10 through networks. Examples of the above-mentioned networks include, but are not limited to, the Internet, enterprise intranets, local area networks, mobile communication networks and their combinations. The processor 106 and other possible components visiting the storage 102 may be performed under the control of the storage controller 104.

The peripheral interface 108 couples various input/(output devices to the CPU and the storage 102. The processor 106 runs various software and instructions in the storage 102 to perform various functions of the client computing device 10 and data processing.

In some embodiments, the peripheral interface 108, the processor 106, and the storage controller 104 may be implemented in a single chip. In some other embodiments, they can be implemented by independent chips, respectively.

The radio frequency module 110 is used to receive and send electromagnetic waves, to realize the conversion between electromagnetic waves and electrical signals, so as to communicate with communication networks or other devices. The radio frequency module 110 may include various existing circuit elements for performing these functions, such as antennas, radio frequency transceivers, digital signal processors, encryption/decryption chips, user identity module (SIM) cards, storages, and so on. The radio frequency module 110 can communicate with various networks such as the Internet, enterprise intranets, wireless networks or communicate with other devices through wireless networks. The above-mentioned wireless networks can include cellular telephone networks, wireless local area networks or metropolitan area networks. These above-mentioned wireless networks can use a variety of communication standards, protocols and technologies, including, but are not limited to, Global System for Mobile Communication (GSM), Enhanced Data GSM Environment (EDGE), Wideband Code Division Multiple Access (W-CDMA), Code Division Multiple Access (CDMA), Time Division Multiple Access (TDMA), Bluetooth, Wireless Fidelity (WiFi) (e.g. IEEE (Institute of Electrical and Electronics Engineers) standards IEEE 802.11a, IEEE 802.11b, IEEE 802.11g, and/or IEEE 802.11n), Voice over Internet Protocal (VoIP), Worldwide Interoperability for Microwave Access (Wi-Max), other protocols for mails, instant messages and short messages, and any other suitable communication protocols, and may even include those that are not developed currently.

The positioning module 112 is used to obtain the current position of the client computing device 10. Examples of the positioning module 112 include, but are not limited to, Global Positioning Systems (GPS), positioning technologies based on wireless local area networks or mobile communication networks.

The camera module 114 is used to take pictures or videos. The pictures or videos took can be stored in the storage 102 and can be sent through the radio frequency module 110.

The audio module 116 provides audio interfaces to users, which may include one or more microphones, one or more loudspeakers, and an audio circuit. The audio circuit receives sound data from the peripheral interface 108, converts the sound data into electrical information, and transmits the electrical information to the loudspeaker. The loudspeaker converts the electrical information into sound waves that can be heard by human ears. The audio circuit also receives electrical information from the microphone, converts the electrical signal into sound data, and transmits the sound data to the peripheral interface 108 for further processing. Audio data can be obtained from the storage 102 or through the radio frequency module 110. In addition, audio data can also be stored in the storage 102 or transmitted through the radio frequency module 110. In some examples, the audio module 116 may also include a headphone jack for providing an audio interface to a headphone or other devices.

The screen 118 provides an output interface between the client computing device 10 and users. Specifically, the screen 118 displays video outputs to the users, the contents of which may include texts, graphics, videos, and any combination thereof. Some output results correspond to some user interface objects. It can be understood that the screen 118 can also include a touch screen. The touch screen provides an output and input interface simultaneously between the client computing device 10 and the users. In addition to displaying the video outputs to the users, the touch screen also receives user inputs, such as user gesture operations like clicking, sliding and so on, so that the user interface objects respond to these user inputs. The techniques for detecting the user inputs may be resistive, capacitive or any other possible touch detection techniques. Specific examples of the touch screen display units include, but are not limited to, liquid crystal displays or luminescent polymer displays.

The button module 120 also provides an interface for the users to input to the client computing device 10, the users can press different buttons to cause the client computing device 10 to perform different functions.

FIG. 4 shows a structure block diagram of a server. As shown in FIG. 4, the server 200 includes: a storage 201, a processor 202, and a network module 203.

It can be understood that the structure shown in FIG. 4 is illustrative only, and the server 200 may also include more or fewer components than those shown in FIG. 4, or may have a configuration different from that shown in FIG. 4. The components shown in FIG. 4 can be implemented by hardware, software or their combination. In addition, the servers in the embodiments of the present invention can also include a plurality of servers with different specific functions.

The Storage 201 can be used to store software programs and modules, such as program instructions/modules corresponding to the case allocation methods, the case allocation systems, the event allocation methods and the event allocation systems in the embodiments of the present invention, the processor 202 runs software programs and modules stored in the storage 201, so as to perform various functional applications and data processing, that is, to realize the case allocation methods and the case allocation systems in the embodiments of the present invention. The storage 201 may include high-speed random access storages and may also include non-volatile storages, such as one or more magnetic storage devices, flash storages, or other non-volatile solid-state storages. In some embodiments, the storage 201 may further include storages set remotely relative to the processor 202, these remote storages can be connected to the server 200 through networks. Furthermore, the above-mentioned software programs and modules can also include: an operation system 221 and a service module 222. Wherein the operating system 221, for example, can be LINUX, UNIX, WINDOWS, and can include various software components and/or drivers used for system management tasks (such as memory management, storage device control, power management, etc.), and can communicate with various hardware or software components, so as to provide running environments for other software components. The service module 222 runs on the basis of the operating system 221, and monitors requests from the networks through the network services of the operating system 221, completes corresponding data processing according to the requests, and returns the processing results to the client computing device. That is to say, the service module 222 is used to provide network services to the client computing device.

The network module 203 is used to receive and send network signals. The above-mentioned network signals may include wireless signals or wired signals. In one example, the above-mentioned network signal is a wired network signal. At this time, the network module 203 may include components such as a processor, a random access storage, a converter, a crystal oscillator, and so on.

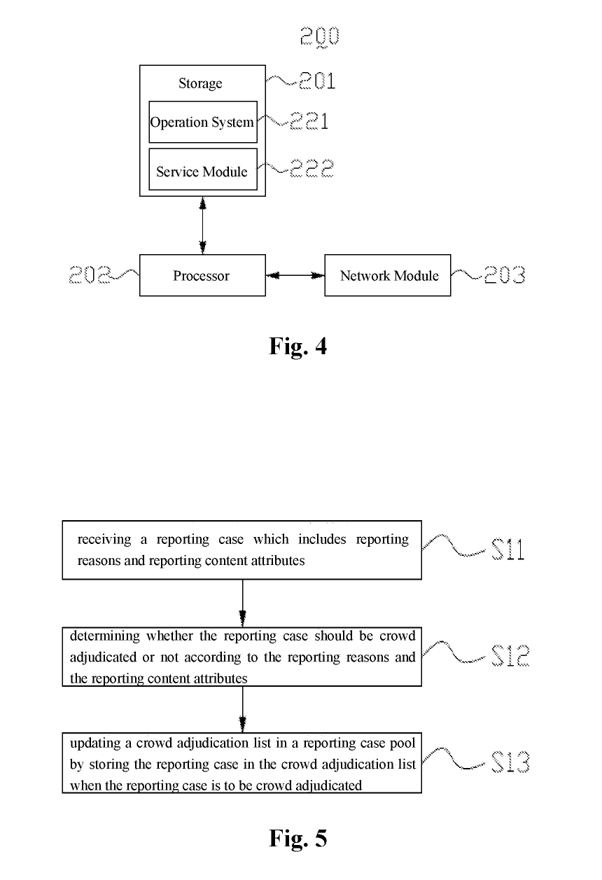

FIG. 5 is a flow chart of the case allocation method of the first embodiment of the present invention. The present embodiment is a case allocation method executed by the server. As shown in FIG. 5, the case allocation method of the present embodiment may include the following steps:

Step S11: receiving a reporting case which includes reporting reasons and reporting content attributes.

Specifically, in the present embodiment, the reporting case may include, but is not limited to, reported videos, reported comments, reported bullet screens, reported tags, and the like. Specifically, when a user reports related videos, comments, bullet screens or tags, the case information related to the reporting case is collected and stored. When the server receives the reporting case, it classifies and stores the reporting case received according to the case information related to the reporting case.

Specifically, in the present embodiment, the reporting content attributes of the reporting case may be, but are not limited to, comments, bullet screens, tags, videos, and the like, and zones corresponding to comments, bullet screens, tags and videos, for example, the video corresponding to the bullet screen is one of animation, drama, music, dance, game, technology, film and television, etc., but it is not limited to this. The reporting reasons of the reporting cases about comments or bullet screens can be, but are not limited to, violation of law and regulation, pornography, vulgarity, gambling fraud, personal attack, invasion of privacy, rubbish advertisement, debate triggering, spoiler, flooding screen, rubbing floor and irrelevant video, etc., the reporting reasons of the reporting cases about tags can be, but are not limited to, irrelevant content, sensitive information, malicious attack, spoiler content, malicious deletion and so on. For example, violation of law and regulation may be, but is not limited to, publishing prohibited information, pornography may be, but is not limited to, publishing pornographic information, vulgarity may be, but is not limited to, publishing vulgar information, gambling fraud may be, but is not limited to, publishing gambling fraud information, personal assault may be, but is not limited to, publishing personal assault speech, invasion of privacy may be, but is not limited to, publishing information that infringes the privacy of others, rubbish advertisement may be, but is not limited to, publishing rubbish advertisement information, debate triggering may be, but is not limited to, publishing debate triggering speech, spoiler may be, but is not limited to, publishing spoiler information, irrelevant content may be, but is not limited to, adding meaningless tags maliciously, sensitive information may be, but is not limited to, publishing prohibited information, malicious attack may be, but is not limited to, publishing personal attack speech, spoiler content may be, but is not limited to, publishing spoiler information, and malicious deletion may be, but is not limited to, deleting utility tags maliciously.

Specifically, in one embodiment, the reporting case can be the one input directly by administrative staff.

Step S12: determining whether the reporting case should be crowd adjudicated or not according to the reporting reasons and the reporting content attributes;

Step S13: updating a crowd adjudication list in a reporting case pool by storing the reporting case in the crowd adjudication list when the reporting case is to be crowd adjudicated.

Specifically, in the present embodiment, the user may initiate, but is not limited to, reporting illegal contents at reporting function entries such as comments, bullet screens, tags, and videos displayed on web pages or client computing devices. After the user initiates a reporting case, the server will receive the reporting case sent by the web page or the client computing device, and reporting reasons and reporting content attributes corresponding to the reporting case. Specifically, the server classifies the reporting case structurally and stores it correspondingly in a reporting case pool according to the reporting reasons when the user submits the reporting case and the position of the content of the reporting case (such as the type of the reporting case and the zone where the reporting case is positioned, etc.).

Specifically, in the present embodiment, the server assigns a crowd adjudication score to the reporting case received according to the reporting reasons and the reporting content attributes, so as to update a crowd adjudication list in a reporting case pool by storing the reporting case in the crowd adjudication list when the crowd adjudication score of the reporting case is greater than a preset crowd adjudication score. Specifically, it can weight, but is not limited to, the reporting reasons and the reporting content attributes so as to obtain the crowd adjudication score of the corresponding reporting case, for example, when the reporting reason of the reporting case is violation of law and regulation, the corresponding crowd adjudication score of the reporting case will be lower, when the reporting reason of the reporting case is personal attack, the corresponding crowd adjudication score of the reporting case will be higher. Specifically, when the server receives a case request, it allocates the reporting case in the crowd adjudication list to the corresponding review account for voting, so as to make a corresponding crowd adjudication result for the reporting case.

Specifically, when the reporting case is not to be crowd adjudicated, an automatic adjudication list in the reporting case pool is updated by storing the reporting case in the automatic adjudication list.

Specifically, in the present embodiment, the server assigns a crowd adjudication score to the reporting case according to the reporting reasons and the reporting content attributes, so as to update the automatic adjudication list in the reporting case pool by storing the reporting case in the automatic adjudication list when the crowd adjudication score of the reporting case is less than or equal to the preset crowd adjudication score. Specifically, the reporting case in the automatic adjudication list will not be allocated to the review account for crowd adjudicating through voting.

Furthermore, whether the content of a second case in the automatic adjudication list is illegal or not is determined; if yes, the user account corresponding to the second case is punished for the illegality; if not, the user account corresponding to the second case is adjudicated not illegal.

Specifically, in the present embodiment, the server may adjudicate, but is not limited to, that the user account corresponding to the second case publishes illegal information, and punish it correspondingly for the illegality, for example, ban the user account corresponding to the second case permanently or for 7 days, and the like, and delete the corresponding illegal information when it detects that the contents of the second case are prohibited information, pornographic information, vulgar information, gambling fraud information and rubbish advertising information.

Specifically, in the present embodiment, the current state of the reporting case in the reporting pool may be, but is not limited to, being distributed, being closed, adjudicated, suspended, not adjudicated, to be restarted, and being frozen. Specifically, being distributed means that the case is being distributed, at this time the review users can obtain the reporting case and vote on the reporting case. Being closed means that the case will be closed soon, at this time the review users can not obtain the reporting case, but can vote on the reporting case. Adjudicated means that the case has been crowd adjudicated, at this time the review users can not obtain the reporting case, can not vote on the reporting case, and there have a crowd adjudication result. Suspended means that the case will not be distributed any longer, at this time the review users can not obtain the reporting case, can not vote on the reporting case, and there is no crowd adjudication result. Not adjudicated means that the voting result of the case does not satisfy the closing conditions, at this time the review users can not obtain the reporting case, can not vote on the reporting case, and there is no crowd adjudication result. To be restarted means that the case to be crowd adjudicated at the next time is generated automatically from a case that is not adjudicated, at this time the review users can not obtain the reporting case, and can not vote on the reporting case. Being frozen means that the case is being frozen by the administrative staff, at this time the review users can not obtain the reporting case, and can not vote on the reporting case, such a reporting case will not be distributed any longer. Specifically, in one embodiment, as to the reporting case transferred or input manually into the reporting pool by the business party, the current state of the reporting case defaults to be “suspended”, but it is not limited to this.

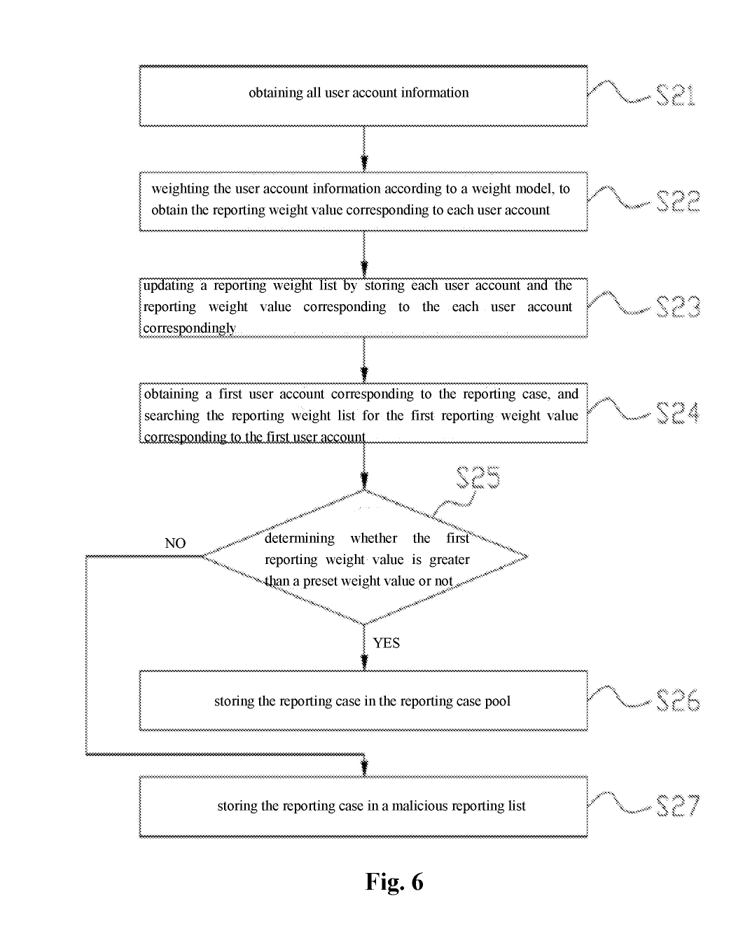

Please refer to FIG. 6, FIG. 6 is a flow chart of the case allocation method of the second embodiment of the present invention. As shown in FIG. 4 and FIG. 5, the case allocation method is implemented by a server, and before Step S12, the case allocation method provided in the present embodiment may comprise, but is not limited to, the following steps:

Step S21: obtaining all user account information.

Specifically, in the present embodiment, the server will obtain all user account information in real time, and the user account information may include, but is not limited to, account information integrity, account historical reporting number, account historical reporting success rate, scores of review institutions and so on.

Step S12: weighting the user account information according to a weight model, to obtain the reporting weight value corresponding to each user account.

Specifically, in the present embodiment, the weight model may obtain, but is not limited to, the reporting weight value of each user account by multiplying the account information integrity, the account historical reporting number, the account historical reporting success rate, the scores of review institutions by corresponding weighting coefficients and then adding up them together. For example, under the conditions that the account historical reporting number corresponding to the user account is bigger and the account historical reporting success rate corresponding to the user account is higher, when the corresponding scores of review institutions is higher and the corresponding account information integrity is more complete, the weighting coefficients corresponding to the account information integrity, the account historical reporting number, the account historical reporting success rate, the scores of review institutions will be higher, then the reporting weight value of the user account obtained is higher. However, when the account historical reporting success rate or the scores of review institutions are lower, the reporting weight value of the user account will be reduced directly and greatly.

Step S23: updating a reporting weight list by storing each user account and the reporting weight value corresponding to the each user account correspondingly.

Step S24: obtaining a first user account corresponding to the reporting case, and searching the reporting weight list for the first reporting weight value corresponding to the first user account.

Specifically, in the present embodiment, after the server obtains the first user account reporting the reporting case, it searches the reporting weight list for the first reporting weight value corresponding to the first user account.

Step S25: determining whether the first reporting weight value is greater than a preset weight value or not;

Specifically, if yes, Step S26: storing the reporting case in the reporting case pool is performed. If not Step S27: storing the reporting case in a malicious reporting list is performed.

Specifically, in the present embodiment, when the first user performs a reporting operation, the server will obtain the reporting weight value corresponding to the first user account, and stores the reporting case whose first reporting weight value is greater than the preset weight value in the reporting case pool. It stores the reporting case whose first reporting weight value is less than or equal to the preset weight value in the malicious reporting list, to block the malicious reporting of the first user, so as to avoid such reporting occupying the audit resources of the review institutions. When the reporting weight value is scored 100 points, the preset weight value may be, not is limited to, 60 points, for example, in other embodiments, the preset weight value may also be set to a score higher or lower than 60 points.

Specifically, the reporting cases are ranked from high to low according to the reporting weight values corresponding to the reporting cases in the crowd adjudication list, and the reporting cases are allocated to corresponding review accounts according to the ranking sequence of the reporting cases in the crowd adjudication list, so as to be crowd adjudicated by review institutions.

Specifically, in the present embodiment, the server can rank all reporting cases in the crowd adjudication list according to the reporting weight values, so as to allocate the reporting weight values from high to low when it receives a case request, so that the reporting cases with higher reporting weight values are processed first, thereby improving the reporting experience of the user.

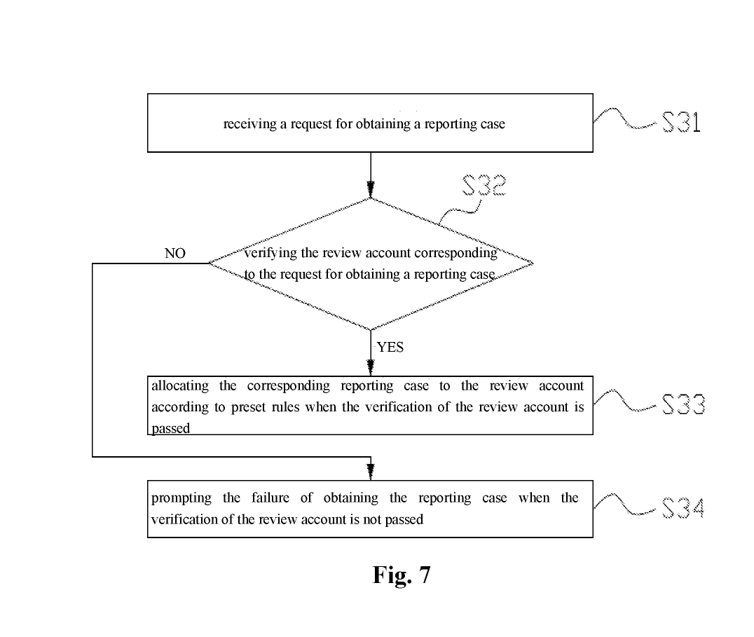

Please refer to FIG. 7, FIG. 7 is a flowchart of the case allocation method of the third embodiment of the present invention. As shown in FIG. 5 and FIG. 7, the case allocation method is implemented by a server, and after Step S13, the case allocation method provided in the present embodiment may comprise, but is not limited to, the following steps:

Step S31: receiving a request for obtaining a reporting case.

Specifically, in the present embodiment, the server monitors in real time whether a request for obtaining a reporting case is received from a review account or not. A request for obtaining a reporting case may include, but is not limited to, review account information and zone information of the review account, etc. For example, the zone information of the review account may be, but is not limited to, videos corresponding to an animation zone or a movie and television zone frequently watched by the user corresponding to the review account, and so on.

Specifically, in one embodiment, when the reporting case meets the preset conditions, the server will allocate the reporting case to all review accounts for voting, so as to crowd adjudicate the reporting case publicly, and provide the discussion of the reporting case to the user to watch. Specifically, the reporting case to be crowd adjudicated publicly may include, but is not limited to, the reporting case that has no upper limits for closing a case automatically by voting, the reporting case that will be distributed at the highest priority to the review account when the distribution begins, the review user having the review qualification can participate in the crowd adjudication of the reporting case by voting, a user can watch the crowd discussion viewpoints on the reporting case released by the review users when the user logs in the user account, a user with a preset level can participate in the discussion zone of the reporting case to discuss. The voting for the reporting case to be crowd adjudicated publicly will be closed 24 hours after the voting begins, the punishment will not be automatically executed after the result of the crowd adjudication voting is published and the reporting case is closed, and the corresponding punishment is executed by audit managers after they review the result of the crowd adjudication voting, but it is not limited to this. Specifically, when a reporting case is to be crowd adjudicated publicly, it is sent directly to all review accounts, without needing the review accounts to send a request for obtaining a reporting case.

Step S32: verifying the review account corresponding to the request for obtaining a reporting case;

Specifically, in the present embodiment, the server authenticates the review accounts corresponding to all requests for obtaining a reporting case, so as to distribute a corresponding reporting case to a voting page corresponding to the review account when the authentication is passed.

Please refer to FIG. 8, FIG. 8 is a flowchart of the substeps of Step S32 in FIG. 7. As shown in FIG. 7 and FIG. 8, the substeps of Step S32 of the case allocation method provided in the present embodiment includes in details:

Substep S321: determining whether the review qualification of the review account corresponding to the request for obtaining a reporting case is valid or not.

Specifically, in the present embodiment, the review qualification may be, but is not limited to, the voting qualification of the review account for crowd adjudicating the reporting case, and the review qualification of the review account is provided with a preset valid time, the review qualification of the review account will be invalid when the preset valid time is expired, but it is not limited to this.

Specifically, if yes, Substep S322: determining whether the voting accurate rate value of the review account is lower than a preset voting accurate rate value or not is performed. If not, Substep S324: prompting that the verification of the review account is not passed.

Specifically, in the present embodiment, when the review qualification of the review account is valid, whether the voting accurate rate value of the review account is lower than a preset voting accurate rate value or not is further determined. Specifically, the voting accurate rate value may be, but is not limited to, the ratio of the voting result of the reporting case made by the review accounts to the final crowd adjudication result of the corresponding reporting case. Specifically, in one embodiment, when the voting number of the review user is greater than or equal to three, the voting accurate rate value of the review account is calculated according to the historical voting situation of the review user. When the voting number of the review user is less than three, the voting accurate rate value of the review account is set default to 50%, but it is not limited to this. Specifically, in the present embodiment, when the review user abstains from voting, the reporting case is regarded as being not voted, and is not calculated in the calculation of the voting accurate rate value.

Specifically, in the present embodiment, when the review qualification of the review account is invalid, that the verification of the review account is not passed will be prompted in the user interface.

Substep S323: prompting that the verification of the review account is passed when the voting accurate rate value of the review account is higher than or equal to the preset voting accurate rate value.

Substep S324: prompting that the verification of the review account is not passed when the voting accurate rate value of the review account is lower than the preset voting accurate rate value.

Specifically, in the present embodiment, the preset voting accurate rate value may be, but is not limited to, 70%, for example, in other embodiments, the preset voting accurate rate value may also be set to a ratio value higher or lower than 70%, for example, the preset rate value is set to 80% or 65% or the like. Specifically, the review account will not be able to obtain the reporting case when the voting accurate rate value is lower than the preset voting accurate rate value.

Step S33: allocating the corresponding reporting case to the review account according to preset rules when the verification of the review account is passed.

Specifically, in the present embodiment, the preset rules may be, but is not limited to, the case whose case status is being distributed and that is not obtained by the review account, the case in which the person reported against is not the user of the review account, the case with the fewest votes in the crowd adjudication list, the case recorded earliest in the crowd adjudication list.

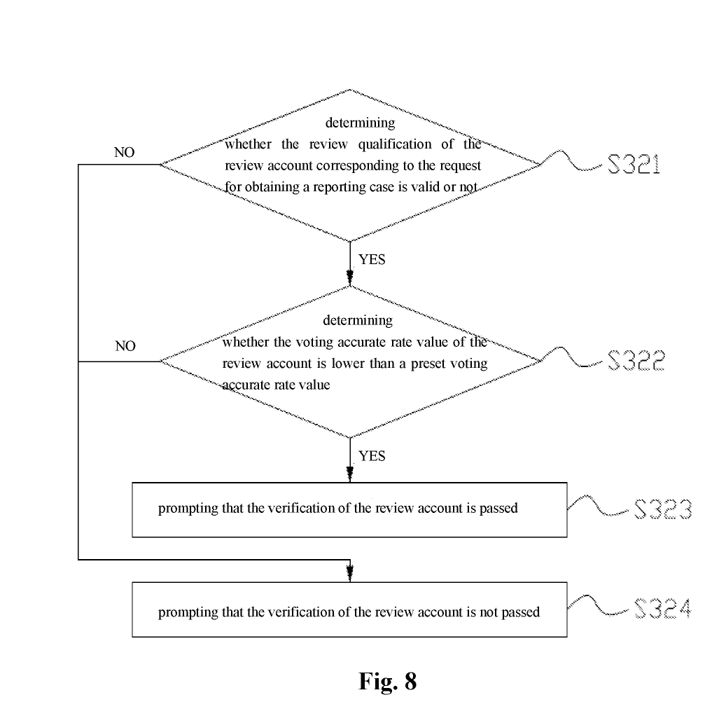

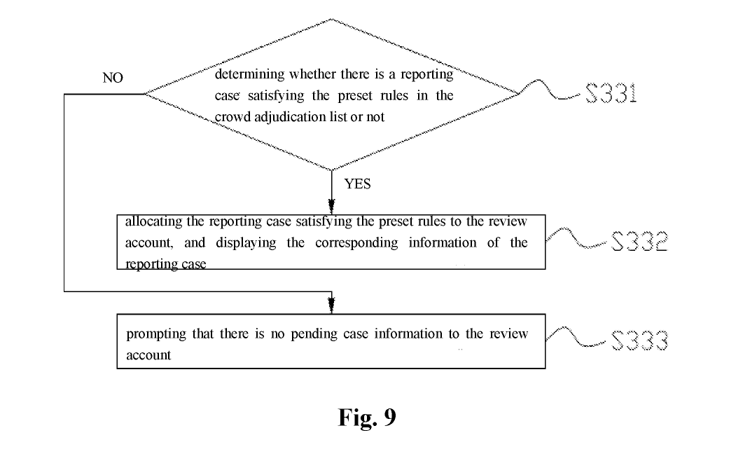

Please refer to FIG. 9, FIG. 9 is a flowchart of the substeps of Step S33 in FIG. 7. As shown in FIG. 7 and FIG. 9, the substeps of Step S33 of the case allocation method provided in the present embodiment includes in details:

Substep S331: determining whether there is a reporting case satisfying the preset rules in the crowd adjudication list or not.

Specifically, if yes, Substep S332: allocating the reporting case satisfying the preset rules to the review account and displaying the corresponding information of the reporting case is performed. If not, Substep S333: prompting that there is no pending case information to the review account is performed.

Specifically, in the present embodiment, after the authentication of the review account is passed, the server allocates the corresponding reporting case to the review account according to the preset rules. For example, the server obtains all reporting cases whose current states are being distributed in the reporting case pool, then obtains the reporting cases that can be distributed by blocking the reporting cases obtained by the review account and the reporting cases in which the corresponding user reported against is the review user of the review account, and then distributes the case with the fewest votes currently or the case input earliest in the reporting cases that can be distributed to the review account, so as to display the reporting case in the voting interface, but it is not limited to this. Furthermore, when there are no qualified cases in the reporting pool, that there is no pending case is prompted in the user interface.

Specifically, in one embodiment, the server also gives the review user a priority to a certain zone according to the number and the time length that the review user browses each zone in the history. Specifically, when the review user has the priority to a certain zone, the server allocates first the reporting cases corresponding to the zone in the reporting case pool to the review account corresponding to the review user, and displays the reporting case and related information about the reporting case in the voting interface.

Specifically, in the present embodiment, the time length of the distribution is the time length that the distribution of the reporting case lasts for, when the time length of the distribution is over, the reporting case enters into the case closing process. The time length of the examination of each reporting case is the longest time limit for the review user to vote after obtaining the reporting case. If the review user has not voted on the reporting case beyond the longest time limit of the reporting case, it is considered that the review user has abstained from voting on the reporting case. Specifically, when the remaining time length of the distribution of a reporting case is less than or equal to the time length of the examination of the reporting case, the server automatically changes the current state of the reporting case from the “being distributed” state to the “being closed” state, and the review user who has obtained the reporting case can continue to vote, the review user who has not obtained the reporting case will not be able to obtain the reporting case, thus avoiding the voting of the review user invalid after he(she) obtains the reporting case.

Specifically, in the present embodiment, the lower limit of the adjudication votes is the minimum number of the votes that is satisfied in adjudicating a case, and when the votes of the reporting case is lower than the lower limit of the adjudication votes, the reporting case will be changed into the “not adjudicated” state after the time length of the distribution is over. The threshold value of the adjudication votes is the lowest ratio that needs to be satisfied by the votes of the reporting case obtained in “illegal” or “legal”, when the votes of the reporting case obtained in “illegal” or “legal” satisfies the threshold value, the reporting case is closed, the crowd adjudication result of the reporting case is that the majority of the votes are obtained in “illegal” or “legal”, and the current state of the reporting case is changed to “adjudicated”. As to the reporting case that does not satisfy the threshold value, when the distribution time is over, the current state of the reporting case is changed to “not adjudicated”, no crowd adjudication result is produced for the reporting case, at the same time, a “to be restarted” reporting case to be crowd adjudicated for the second time is generated automatically. Specifically, the interval for restarting the crowd adjudication is the time interval between the last time that the reporting case can not be crowd adjudicated by voting and the next time to restart the crowd adjudication, a second adjudication interval and a third adjudication interval or more adjudication intervals can be set respectively. The server begins to calculate time from the generation time of the “to be restarted” case, and automatically changes the status of the “to be restarted” case to “being distributed” after a preset interval, and displays the number of the crowd adjudication of the reporting case in the voting interface.

Step S34: prompting the failure of obtaining the reporting case when the verification of the review account is not passed.

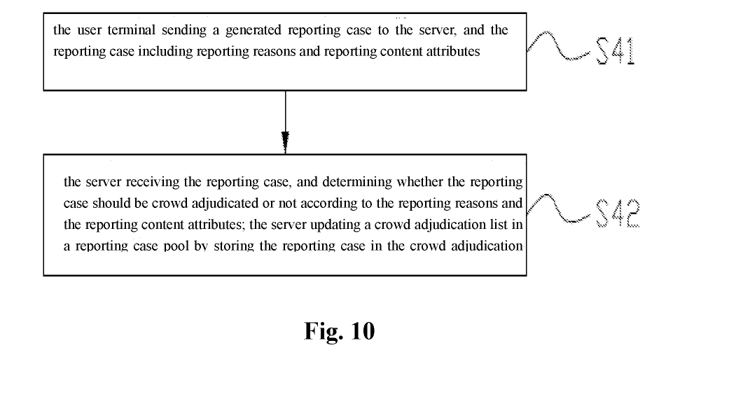

Please refer to FIG. 10, FIG. 10 is a flowchart of the case allocation method of the fourth embodiment of the present invention. The case allocation method is implemented by a server and a client computing device. The case allocation method provided in the present embodiment may comprise, but is not limited to, the following steps:

Step S41: the user terminal sending a generated reporting case to the server, and the reporting case including reporting reasons and reporting content attributes.

Step S42: the server receiving the reporting case, and determining whether the reporting case should be crowd adjudicated or not according to the reporting reasons and the reporting content attributes; the server updating a crowd adjudication list in a reporting case pool by storing the reporting case in the crowd adjudication list when the reporting case is to be crowd adjudicated.

Specifically, in the present embodiment, the reporting case may include, but is not limited to, reported videos, reported comments, reported bullet screens, reported tags, and the like. Specifically, when a user reports related videos, comments, bullet screens or tags, the case information related to the reporting case is collected and stored. When the server receives the reporting case, it classifies and stores the reporting case received according to the case information related to the reporting case.

Specifically, in the present embodiment, the reporting content attributes of the reporting case may be, but are not limited to, comments, bullet screens, tags, videos, and the like, and zones corresponding to comments, bullet screens, tags and videos, for example, the video corresponding to the bullet screen is one of animation, drama, music, dance, game, technology, film and television, etc., but it is not limited to this. The reporting reasons of the reporting cases about comments or bullet screens can be, but are not limited to, violation of law and regulation, pornography, vulgarity, gambling fraud, personal attack, invasion of privacy, rubbish advertisement, debate triggering, spoiler, flooding screen, rubbing floor and irrelevant video, etc., the reporting reasons of the reporting cases about tags can be, but are not limited to, irrelevant content, sensitive information, malicious attack, spoiler content, malicious deletion and so on. For example, violation of law and regulation may be, but is not limited to, publishing prohibited information, pornography may be, but is not limited to, publishing pornographic information, vulgarity may be, but is not limited to, publishing vulgar information, gambling fraud may be, but is not limited to, publishing gambling fraud information, personal assault may be, but is not limited to, publishing personal assault speech, invasion of privacy may be, but is not limited to, publishing information that infringes the privacy of others, rubbish advertisement may be, but is not limited to, publishing rubbish advertisement information, debate triggering may be, but is not limited to, publishing debate triggering speech, spoiler may be, but is not limited to, publishing spoiler information, irrelevant content may be, but is not limited to, adding meaningless tags maliciously, sensitive information may be, but is not limited to, publishing prohibited information, malicious attack may be, but is not limited to, publishing personal attack speech, spoiler content may be, but is not limited to, publishing spoiler information, and malicious deletion may be, but is not limited to, deleting utility tags maliciously.

Specifically, in one embodiment, the reporting case can be the one input directly by administrative staff.

Specifically, in the present embodiment, the user may initiate, but is not limited to, reporting illegal contents at reporting function entries such as comments, bullet screens, tags, and videos displayed on web pages or client computing devices. After the user initiates a reporting case, the client computing device will generate a reporting case and send the reporting case to the server. The server will receive the reporting case sent by the web page or the client computing device, and reporting reasons and reporting content attributes corresponding to the reporting case. Specifically, the server classifies the reporting case structurally and stores it correspondingly in a reporting case pool according to the reporting reasons when the user submits the reporting case and the position of the content of the reporting case (such as the type of the reporting case and the zone where the reporting case is positioned, etc.).

Specifically, in the present embodiment, the server assigns a crowd adjudication score to the reporting case received according to the reporting reasons and the reporting content attributes, so as to update a crowd adjudication list in a reporting case pool by storing the reporting case in the crowd adjudication list when the crowd adjudication score of the reporting case is greater than a preset crowd adjudication score. Specifically, it can weight, but is not limited to, the reporting reasons and the reporting content attributes so as to obtain the crowd adjudication score of the corresponding reporting case, for example, when the reporting reason of the reporting case is violation of law and regulation, the corresponding crowd adjudication score of the reporting case will be lower, when the reporting reason of the reporting case is personal attack, the corresponding crowd adjudication score of the reporting case will be higher. Specifically, when the server receives a case request, it allocates the reporting case in the crowd adjudication list to the corresponding review account for voting, so as to make a corresponding crowd adjudication result for the reporting case.

Furthermore, when the reporting case is not to be crowd adjudicated, an automatic adjudication list in the reporting case pool is updated by storing the reporting case in the automatic adjudication list.

Specifically, in the present embodiment, the server assigns a crowd adjudication score to the reporting case according to the reporting reasons and the reporting content attributes, so as to update the automatic adjudication list in the reporting case pool by storing the reporting case in the automatic adjudication list when the crowd adjudication score of the reporting case is less than or equal to the preset crowd adjudication score. Specifically, the reporting case in the automatic adjudication list will not be allocated to the review account for crowd adjudicating through voting.

Furthermore, whether the content of a second case in the automatic adjudication list is illegal or not is determined; if yes, the user account corresponding to the second case is punished for the illegality; if not, the user account corresponding to the second case is adjudicated not illegal.

Specifically, in the present embodiment, the server may adjudicate, but is not limited to, that the user account corresponding to the second case publishes illegal information, and punish it correspondingly for the illegality, for example, ban the user account corresponding to the second case permanently or for 7 days, and the like, and delete the corresponding illegal information when it detects that the contents of the second case are prohibited information, pornographic information, vulgar information, gambling fraud information and rubbish advertising information.

Specifically, in the present embodiment, the current state of the reporting case in the reporting pool may be, but is not limited to, being distributed, being closed, adjudicated, suspended, not adjudicated, to be restarted, and being frozen. Specifically, being distributed means that the case is being distributed, at this time the review users can obtain the reporting case and vote on the reporting case. Being closed means that the case will be closed soon, at this time the review users cannot obtain the reporting case, but can vote on the reporting case. Adjudicated means that the case has been crowd adjudicated, at this time the review users cannot obtain the reporting case, cannot vote on the reporting case, and there have a crowd adjudication result. Suspended means that the case will not be distributed any longer, at this time the review users cannot obtain the reporting case, cannot vote on the reporting case, and there is no crowd adjudication result. Not adjudicated means that the voting result of the case does not satisfy the closing conditions, at this time the review users cannot obtain the reporting case, cannot vote on the reporting case, and there is no crowd adjudication result. To be restarted means that the case to be crowd adjudicated at the next time is generated automatically from a case that is not adjudicated, at this time the review users cannot obtain the reporting case, and cannot vote on the reporting case. Being frozen means that the case is being frozen by the administrative staff, at this time the review users cannot obtain the reporting case, and cannot vote on the reporting case, such a reporting case will not be distributed any longer. Specifically, in one embodiment, as to the reporting case transferred or input manually into the reporting pool by the business party, the current state of the reporting case defaults to be “suspended”, but it is not limited to this.

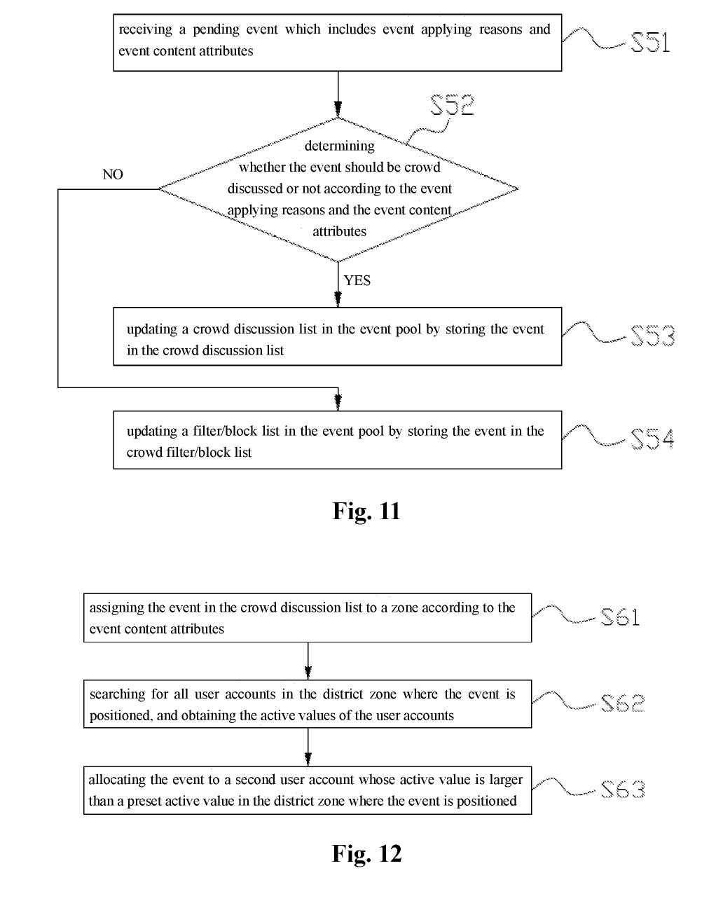

Please refer to FIG. 11, FIG. 11 is a flow chart of the event allocation method of the fifth embodiment of the present invention. The event allocation method is implemented by a server, as shown in FIG. 11, the event allocation method of the present embodiment includes the following steps:

Step S51: receiving a pending event which includes event applying reasons and event content attributes.

Specifically, in the present embodiment, the event may include, but is not be limited to, the crowd discussing topic case of discussing viewpoints of real-time news and film and television works, the social hot topic case and the reporting case.

Step S52: determining whether the event should be crowd discussed or not according to the event applying reasons and the event content attributes.

Specifically, if yes, Step S53: updating a crowd discussion list in an event pool by storing the event in the crowd discussion list is performed. If not, Step S54: updating a filter/block list in the event pool by storing the event in the crowd filter/block list.

Specifically, in the present embodiment, the server judges the event received, so as to store the event in the crowd discussion list in the event pool, and distribute the event to corresponding users for hot discussion when the event meets the crowd discussion condition, to guide a good social phenomenon. When the event does not meet the crowd discussion condition, the server stores the event in the filter/block list in the event pool, and the events in the filter/block list will not be allocated to the user. The crowd discussion condition may be, but is not limited to, whether the crowd discussion score of the event after weighting the applying reasons and the event content attributes reaches the preset score or not, but it is not limited to this.

Please refer to FIG. 12, FIG. 12 is a flowchart of the event allocation method of the sixth embodiment of the present invention. The event allocation method is implemented by a server, as shown in FIG. 11 and FIG. 12, after the step of updating a crowd discussion list in an event pool by storing the event in the crowd discussion list, the event allocation method of the present embodiment further comprises in details:

Step S61: assigning the event in the crowd discussion list to a zone according to the event content attributes.

Specifically, in the present embodiment, when the content of the event is real-time news, the event can be stored in the news zone, and when the content of the event is video and television content, the event can be stored in an viewpoint discussion zone of the film and television works, but it is not limited to this.

Step S62: searching for all user accounts in the zone where the event is positioned, and obtaining the active values of the user accounts.

Step S63: allocating the event to a second user account whose active value is larger than a preset active value in the zone where the event is positioned.

Specifically, in the present embodiment, the active value may be, but is not limited to, the times that the user participates in the crowd discussions of various events in the zone, if the times that the user participates in the crowd discussions of various events are more, the active value of the user account corresponding to the user is higher. And the event is allocated to all user accounts whose active values are larger than a preset active value in the zone where the event is positioned, so as to increase the intensity of the discussion of the zone and improve the user experience.

The event allocation method provided in the present embodiment can quickly allocate the corresponding event to the user when the user request is received by classifying the events according to the reasons and the attributes of the events, so as to be capable of effectively improving the allocation efficiency of events, and allocating events to corresponding users according to the attributes of the events, so as to create a good network community phenomenon and enhance user experience.

FIG. 13 is a structure block diagram of the server 230 of the seventh embodiment of the present invention. As shown in FIG. 13, the server 230 provided in the present embodiment is used to execute the case allocation method, and the server 230 provided in the present embodiment includes a storage 231 and a processor 232. Specifically, as to the specific structure of the server 230, the server 200 shown in FIG. 3 can further be referred to.

Specifically, in the present embodiment, the storage 231 is used to store executable program codes; and the processor 232 is used to invoke the executable program codes in the storage 231, the execution steps include: receiving a reporting case which includes reporting reasons and reporting content attributes; determining whether the reporting case should be crowd adjudicated or not according to the reporting reasons and the reporting content attributes; updating a crowd adjudication list in a reporting case pool by storing the reporting case in the crowd adjudication list when the reporting case is to be crowd adjudicated.

Specifically, the server 230 is also used to update an automatic adjudication list in the reporting case pool by storing the reporting case in the automatic adjudication list when the reporting case is not to be crowd adjudicated.

Specifically, the server 230 is also used to determine whether the content of a second case in the automatic adjudication list is illegal or not; punish the user account corresponding to the second case for the illegality, if yes; adjudicate the user account corresponding to the second case not illegal, if not.

Specifically, the server 230 is also used to obtain all user account information; weight the user account information according to a weight model, to obtain the reporting weight value corresponding to each user account; update a reporting weight list by storing each user account and the reporting weight value corresponding to the each user account correspondingly.

Specifically, the server 230 is also used to obtain a first user account corresponding to the reporting case, and searching the reporting weight list for the first reporting weight value corresponding to the first user account; determine whether the first reporting weight value is greater than a preset weight value or not; store the reporting case in the reporting case pool, if yes; store the reporting case in a malicious reporting list, if not.

Specifically, the server 230 is also used to rank the reporting cases from high to low according to the reporting weight values corresponding to the reporting cases in the crowd adjudication list, and allocate the reporting cases to corresponding review accounts according to the ranking sequence of the reporting cases in the crowd adjudication list, so as to be crowd adjudicated by review institutions.

Specifically, the user account information includes account information integrity, account historical reporting number, account historical reporting success rate, and scores of review institutions.

Specifically, the server 230 is also used to receive a request for obtaining a reporting case; verify the review account corresponding to the request for obtaining a reporting case; allocate the corresponding reporting case to the review account according to preset rules when the verification of the review account is passed; prompt the failure of obtaining the reporting case when the verification of the review account is not passed.

Specifically, the server 230 is also used to determine whether the review qualification of the review account corresponding to the request for obtaining a reporting case is valid or not; determine whether the voting accurate rate value of the review account is lower than a preset voting accurate rate value, if yes; prompt that the verification of the review account is not passed, if not.

Specifically, the server 230 is also used to prompt that the verification of the review account is passed when the voting accurate rate value of the review account is higher than or equal to the preset voting accurate rate value; prompt that the verification of the review account is not passed when the voting accurate rate value of the review account is lower than the preset voting accurate rate value.

Specifically, the server 230 is also used to determine whether there is a reporting case satisfying the preset rules in the crowd adjudication list or not; allocate the reporting case satisfying the preset rules to the review account, and display the corresponding information of the reporting case, if yes; prompt that there is no pending case information to the review account, if not.

Specifically, the preset rules include the case whose case status is being distributed and that is not obtained by the review account, the case in which the person reported against is not the user of the review account, the case with the fewest votes in the crowd adjudication list, the case recorded earliest in the crowd adjudication list.

Specifically, in the present embodiment, as to the specific structure of the server 230, please refer to the structure of the server 200 shown in FIG. 4, and it will not be repeated here.

As to the specific processes in which various functional units of the server 230 of the present embodiment carry out their own functions respectively, please refer to the specific content described in the embodiments shown in FIG. 5 and FIG. 9 mentioned above, and it will not be repeated here.

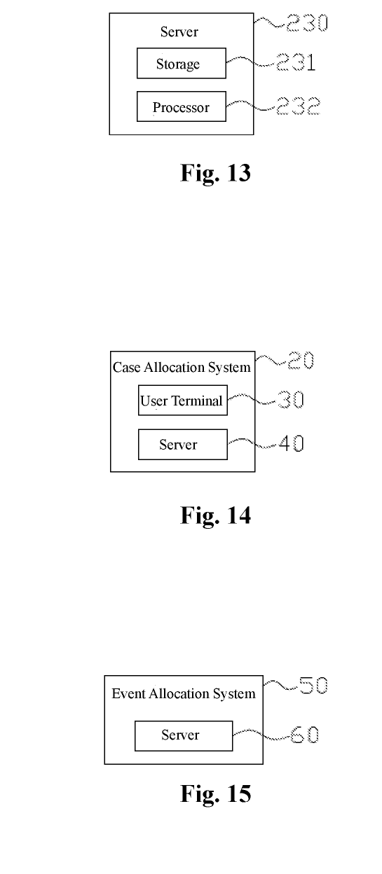

FIG. 14 is a structure block diagram of the case allocation system 20 of the eighth embodiment of the present invention. As shown in FIG. 14, the case allocation system 20 provided in the present embodiment can be used to carry out the case allocation method, the case allocation system 20 includes a client computing device 30 and a server 40.

Specifically, in the present embodiment, the client computing device 30 is configured to send a generated reporting case to the server, and the reporting case includes reporting reasons and reporting content attributes. The server 40 is configured to receive the reporting case, and determine whether the reporting case should be crowd adjudicated or not according to the reporting reasons and the reporting content attributes; the server 40 is also configured to update a crowd adjudication list in a reporting case pool by storing the reporting case in the crowd adjudication list when the reporting case is determined to be crowd adjudicated.

Specifically, the server 40 is also configured to update an automatic adjudication list in the reporting case pool by storing the reporting case in the automatic adjudication list when the reporting case is not to be crowd adjudicated.

As to the specific processes in which various functional units of the case allocation system 20 of the present embodiment carry out their own functions respectively, please refer to the specific content described in the embodiment shown in FIG. 9 mentioned above, and it will not be repeated here.

FIG. 15 is a structure block diagram of the event allocation system 50 of the ninth embodiment of the present invention. As shown in FIG. 15, the event allocation system 50 provided in the present embodiment can be used to carry out the event allocation method, and the event allocation system 50 includes a server 60. The server 60 includes: a storage, used to store executable program codes; and a processor, used to invoke the executable program codes, the execution steps include: receiving a pending event which includes event applying reasons and event content attributes; determining whether the event should be crowd discussed or not according to the event applying reasons and the event content attributes; updating a crowd discussion list in the event pool by storing the event in the crowd discussion list, if yes; updating a filter/block list in the event pool by storing the event in the crowd filter/block list, if not.

Specifically, the server 60 is also configured to assign the event in the crowd discussion list to a zone according to the event content attributes; search for all user accounts in the zone where the event is positioned, and obtain the active values of the user accounts; allocate the event to a second user account whose active value is larger than a preset active value in the zone where the event is positioned.

Specifically, the event includes the crowd discussing topic case of discussing viewpoints of real-time news and film and television works, the social hot topic case and the reporting case.

The above-mentioned server may include, but is not limited to, one or more second processors and one or more second storages. The second storage can be used to store software programs and modules, and the second processor performs various functional applications and data processing by running the software programs and the modules stored in the second storage.

The server, the case allocation method, the case allocation system, the event allocation method and the event allocation system provided by the present invention can quickly allocate the corresponding reporting case to the user when the user request is received by classifying the reporting cases according to the reasons and the attributes of the reporting cases, so as to be capable of effectively improving the allocation efficiency of reporting cases, and allocate reporting cases to corresponding users according to the attributes of the reporting cases, so as to create a good network community phenomenon and enhance user experience.

In addition, the embodiments of the present invention also provide a computer-readable storage medium in which computer-executable instructions are stored, the computer-readable storage medium can be, for example, non-volatile storages such as optical disks, hard disks, or Flash memories. The above-mentioned computer executable instructions are used to allow a computer or similar computing devices to perform various operations in the case allocation method and the event allocation method described above.

It should be noted that, the various embodiments in this specification are described in a progressive manner, each of which focuses on the differences from other embodiments, and the same and similar parts among the various embodiments can be referred to each other. For client computing device embodiments, because they are basically similar to the method embodiments, their descriptions are relatively simple, and the relevant points can just be referred to parts of the descriptions of the method embodiments.

What is claimed is:

1. A computer-implemented method of processing events, comprising:
receiving an event from a first user account, the event comprising information indicative of at least one reason for submitting the event and at least one attribute of content associated with the event;
determining whether the event is to be crowd discussed based on at least in part on the information indicative of at least one reason and the at least one attribute of content, wherein the determining whether the event is to be crowd discussed further comprises determining a crowd discussion value of the event by weighing the at least one reason and the at least one attribute of content;
in response to a determination that the event is to be crowd discussed, updating a crowd discussion list in an event pool and storing the event in the crowd discussion list; and
in response to a determination that the event is not to be crowd discussed, updating a filter or block list in the event pool and storing the event in the crowd filter or block list.

2. The computer-implemented method of claim 1, further comprising:
assigning the event in the crowd discussion list to a zone based at least in part on the at least one attribute of content associated with the event;
searching a plurality of user accounts in the zone and obtaining a plurality of active values corresponding to the plurality of user accounts, wherein each of the plurality of active values is determined based at least in part on a number of crowd discussion events in the zone in which a corresponding user account has participated; and
allocating the event to a user account among the plurality of user accounts whose active value is greater than a predetermined active value in the zone.

3. The computer-implemented method of claim 1, wherein the event is associated with at least one of a topic of crowd discussion of real-time news, movies, or television programs; a hot social topic; or a report.

4. The computer-implemented method of claim 3, wherein the event is a first report from the first user account.

5. The computer-implemented method of claim 4, further comprising:
reading information associated with a second plurality of user accounts from a storage device;
determining a plurality of report weight values corresponding to the second plurality of user accounts by applying a weigh model to the information associated the second plurality of user accounts;
determining whether the first report is to be crowd adjudicated based at least in part on a report weigh value corresponding to the first user account, the at least one reason, and the at least one attribute of content; and
in response to a determination that the first report is to be crowd adjudicated, updating a crowd adjudication list in a report pool and storing the first report in the crowd adjudication list.

6. The computer-implemented method of claim 5, further comprising:
in response to a determination that the report is not to be crowd adjudicated, updating an automatic adjudication list in the report pool and storing the first report in the automatic adjudication list.

7. The computer-implemented method of claim 6, further comprising:
determining whether content associated with a second report in the automatic adjudication list is prohibited based on predetermined rules; and
determining whether a second user account associated with the second report is to be penalized based on predetermined rules.

8. The computer-implemented method of claim 5, wherein the information associated with the second plurality of user accounts includes account integrity, numbers of historical reports, success rates of historical reports, and scores given by a plurality of review accounts.

9. The computer-implemented method of claim 5, further comprising:
obtaining account information of the first user account from the report;
obtaining the report weight value corresponding to the first user account based on the account information of the first user account;
determining whether the report weight value is greater than a predetermined weight value;
in response to a determination that the report weight value is greater than the predetermined weight value, storing the first report in the report pool; and
in response to a determination that the report weight value is not greater than the predetermined weight value, storing the first report in a malicious report list.

10. The computer-implemented method of claim 5, further comprising:
ranking a plurality of reports stored in the crowd adjudication list based on report weight values of corresponding user accounts filing the plurality of reports; and
allocating the plurality of reports to a plurality of review accounts according to a ranking of the plurality of reports in the crowd adjudication list.

11. The computer-implemented method of claim 5, further comprising:
receiving a request, from a review account among a plurality of review accounts, for obtaining any report stored in the crowd adjudication list;
verifying the review account based on predetermined rules;
in response to a determination that the review account passes a verification, determining whether to allocate any report in the crowd adjudication list to the review account based on a plurality of predetermined rules; and
in response to a determination that the review account does not pass the verification, prompting a notification that the review account fails to obtain the first report.

12. The computer-implemented method of claim 11, wherein the verifying the review account based on predetermined rules further comprises:
determining whether a review qualification of the review account is valid; and
determining whether a voting accurate rate value associated with the review account is lower than a predetermined voting accurate rate value.

13. The computer-implemented method of claim 11, wherein the plurality of predetermined rules comprise whether a report is in a status of being distributed, whether a same report has been obtained by the review account, whether a user being reported is associated with the review account, whether a report receives a fewest number of votes among a plurality of reports stored in the crowd adjudication list, and whether a report is an earliest report stored in the crowd adjudication list.

14. The computer-implemented method of claim 13, wherein the determining whether to allocate a report to the review account based on a plurality of predetermined rules further comprises:
determining whether there is at least one report stored in the crowd adjudication list that satisfies the plurality of predetermined rules;
allocating a report that satisfies the plurality of predetermined rules to the review account and presenting information associated with the report to the review account; and
prompting the review account a notification that there is no pending report in response to a determination that there is no report in the crowd adjudication list that satisfies the plurality of predetermined rules.

15. A computing system of processing reports, comprising:
a processor; and
a memory communicatively coupled to the processor to configure the processor at least to:
receive an event from a first user account, the event comprising information indicative of at least one reason for submitting the event and at least one attribute of content associated with the event;
determine whether the event is to be crowd discussed based on at least in part on the information indicative of at least one reason and the at least one attribute of content, wherein the determining whether the event is to be crowd discussed further comprises determining a crowd discussion value of the event by weighing the at least one reason and the at least one attribute of content;
in response to a determination that the event is to be crowd discussed, update a crowd discussion list in an event pool and store the event in the crowd discussion list; and
in response to a determination that the event is not to be crowd discussed, update a filter or block list in the event pool and store the event in the crowd filter or block list.

16. The computing system of claim 15, wherein the event is a first report from the first user account.

17. The computing system of claim 16, the memory further configuring the processor at least to:
determine a plurality of report weight values corresponding to the second plurality of user accounts by applying a weigh model to information associated the second plurality of user accounts;
determine whether the first report is to be crowd adjudicated based at least in part on a report weigh value corresponding to the first user account, the at least one reason, and the at least one attribute of content; and
in response to a determination that the first report is to be crowd adjudicated, update a crowd adjudication list in a report pool and store the first report in the crowd adjudication list.

18. The computing system of claim 17, the memory further configuring the processor at least to:
receive a request, from a review account among a plurality of review accounts, for obtaining any report stored in the crowd adjudication list;
in response to a determination that the review account passes a verification, determine whether to allocate any report in the crowd adjudication list to the review account based on a plurality of predetermined rules, wherein the plurality of predetermined rules comprises whether a report is in a status of being distributed, whether a same report has been obtained by the review account, whether a user being reported is associated with the review account, whether a report receives a fewest number of votes among a plurality of reports stored in the crowd adjudication list, and whether a report is an earliest report stored in the crowd adjudication list.

19. A non-transitory computer-readable storage medium bearing computer-readable instructions that upon execution on a computing device cause the computing device at least to:
receive an event from a first user account, the event comprising information indicative of at least one reason for submitting the event and at least one attribute of content associated with the event;
determine whether the event is to be crowd discussed based on at least in part on the information indicative of at least one reason and the at least one attribute of content, wherein the determining whether the event is to be crowd discussed further comprises determining a crowd discussion value of the event by weighing the at least one reason and the at least one attribute of content;
in response to a determination that the event is to be crowd discussed, update a crowd discussion list in an event pool and store the event in the crowd discussion list; and
in response to a determination that the event is not to be crowd discussed, update a filter or block list in the event pool and store the event in the crowd filter or block list.

20. The non-transitory computer-readable storage medium of claim 19, wherein the event is a first report from the first user account, and the non-transitory computer-readable storage medium further comprises computer-readable instructions that upon execution on the computing device cause the computing device at least to:
determine whether the first report is to be crowd adjudicated based at least in part on a report weigh value corresponding to the first user account, the at least one reason, and the at least one attribute of content;
in response to a determination that the report is to be crowd adjudicated, update a crowd adjudication list in a report pool and store the first report in the crowd adjudication list;
receive a request, from a review account among a plurality of review accounts, for obtaining any report stored in the crowd adjudication list; and
in response to a determination that the review account passes a verification, determine whether to allocate any report in the crowd adjudication list to the review account based on a plurality of predetermined rules, wherein the plurality of predetermined rules comprises whether a report is in a status of being distributed, whether a same report has been obtained by the review account, whether a user being reported is associated with the review account, whether a report receives a fewest number of votes among a plurality of reports stored in the crowd adjudication list, and whether a report is an earliest report stored in the crowd adjudication list.
